(19) United States
(12) Patent Application Publication
(10) Pub. No.: US 2013/0309410 A1
(43) Pub. Date: Nov. 21, 2013

(54) Late-Stage Customization of Steel

(71) Applicant: ARCANUM ALLOY DESIGN INC., Sunnyvale, CA (US)

(72) Inventors: Daniel E. Bullard, Valparaiso, IN (US); Joseph E. McDermott, Sunnyvale, CA (US)

(73) Assignee: Arcanum Alloy Design Inc., Sunnyvale, CA (US)

(21) Appl. No.: 13/799,034

(22) Filed: Mar. 13, 2013

Related U.S. Application Data
(63) Continuation-in-part of application No. 13/629,699, filed on Sep. 28, 2012.
(60) Provisional application No. 61/772,564, filed on Mar. 5, 2013.
(60) Provisional application No. 61/646,980, filed on May 15, 2012.

(51) Int. Cl. B05D 3/02

(52) U.S. Cl. CPC B05D 3/0254
USPC 427/455; 427/383.7; 427/250; 164/76.1; 205/224

(57) ABSTRACT

A metal customization process that provides an alloy metal product which meets predefined product specifications which are typically based on whole thickness materials. The metal customization process can be used with any commercially available substrates (e.g., aluminum bar, aluminum coil, steel bar, steel coil, and alloys thereof) but, preferably, the substrate is made of steel (e.g., carbon steel, low carbon steel or steel alloys). This process can include receiving a product specification that can include performance or composition criteria; converting the product specification to a surface specification and a core specification; then treating a substrate with a deposition composition, for example, at a temperature below an annealing temperature, thereby depositing at least one alloying element onto the substrate to form a coating composition that is carried by the substrate; and then annealing the coated substrate to provide a product that meets the product specification.

### CROSS-REFERENCE

A benefit of priority is claimed to U.S. Provisional Patent Application No. 61/646,980 filed 15 May, 2012, U.S. Provisional Patent Application No. 61/772,564 filed 5 Mar., 2013, and U.S. patent application Ser. No. 13/629,699 filed 28 Sep., 2012, the disclosures of which are incorporated herein in their entirety.

### FIELD OF THE INVENTION

This disclosure is related to the late-stage customization of steels, alloys, and other metals during the manufacturing process that starts with bulk materials such as coil, ore, and scrap metal.

### BACKGROUND

The typical process of forming steel alloys includes the formation of a liquid alloy composition that has the approximate composition of the desired/final steel alloy. This process includes melting, casting, and rolling of large volumes of iron, nickel, chromium, tungsten and/or other alloying elements. The rolling of the steel alloys often requires multiple rolling/heat treatment steps to prevent the cracking and work hardening of the steel alloy. These repetitive steps add significant costs and time to the production of the steel alloy.

Furthermore, the production of the steel alloy is never perfect. The process includes the production of scrap, yield loss, and at times the production of low quality steel alloys. These problems add to the material and energy costs for the production of the steel alloy.

To reduce the variation in the steel product and some of the costs, steel casting lines are typically operated in a continuous fashion. These continuous steel casting lines produce a single steel alloy. The production of a second steel alloy requires either a second casting line or shutting down the first line and restarting with a new alloy composition. Notably, this conversion of the steel casting line for the production of second steel grade involves a significant loss of time, money and materials.

Another tactic used to reduce the costs associated with manufacturing steel alloys is the standardization or grading of steel. (e.g., 316 Stainless, 403 Stainless). The standardization allows the commoditization of the steel and the steel mill to produce, catalogue, and sell the commodity to a consumer. This prevents the consumer having input on the composition and/or performance of the offered product. That is, if the steel grades offered by a steel mill do not meet the consumer's demand either the steel mill or the consumer suffers.

### SUMMARY

Herein is disclosed a steel customization process. This process can include receiving a product specification that can include performance or composition criteria; converting the product specification to a surface specification and a core specification; then treating a substrate with a deposition composition, for example, at a temperature below an annealing temperature, thereby depositing at least one alloying element onto the substrate to form a coating composition that is carried by the substrate; then confirming that the product meets the product specification.

### DESCRIPTION OF THE DRAWING

For a more complete understanding of the disclosure, reference should be made to the following detailed description and accompanying drawing figure wherein:

FIG. 1 depicts one embodiment of the steel customization process described herein.

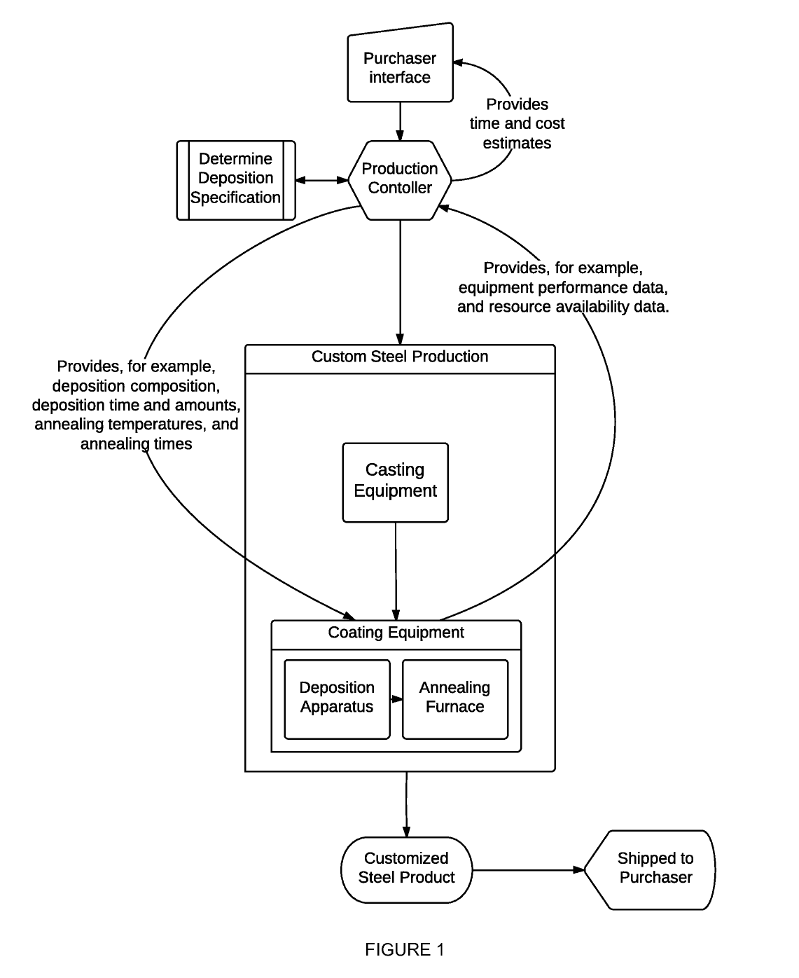

While the disclosed process and compositions are susceptible of embodiments in various forms, there are illustrated in the description and figure (as will hereafter be described) specific embodiments of the compositions and processes, with the understanding that the disclosure is intended to be illustrative, and is not intended to limit the invention to the specific embodiments described and illustrated herein.

### DETAILED DESCRIPTION

Described herein is a metal customization process that provides a coated metal product which meets predefined product specifications that are typically based on whole thickness materials. Herein, the metal customization process can be used with any commercially available substrates (e.g., aluminum bar, aluminum coil, steel bar, steel coil, and alloys thereof) but, preferably, the substrate is made of steel (e.g., carbon steel, low carbon steel or steel alloys). As used herein and throughout the industry, “steel” is an alloy of iron and at least one other element. Preferably, steel refers to the alloy of iron and carbon of which many classes exist (e.g., pig iron, cast iron, carbon steel, low carbon steel, and very low carbon steel).

In a first embodiment, the steel customization process can include receiving a first product specification that includes criteria selected from the group consisting of performance criteria, composition criteria, thickness criteria, and a combination thereof. Preferably, the product specification/specifications is/are received from a purchaser.

The process further includes converting the first product specification to a first surface specification that includes a first surface alloy composition and a first surface alloy thickness, and a first core specification that includes a first core composition and a first core thickness. Additionally, the process can include converting the product specification to a deposition specification that includes the substrate composition, the substrate thickness, the coating composition, and a coating composition thickness.

The process additionally includes providing a plurality of substrates that individually have the same substrate composition and substrate thickness. In one preferable example, the plurality of substrates carbon steel. That is, the plurality of substrates have the same composition and are a carbon steel, low carbon steel, or very low carbon steel. In another example, providing the plurality of substrates can include casting a molten metal or metal alloy to produce the plurality of substrates (e.g., casting and rolling a carbon steel to provide the plurality of substrates).

After providing the substrates, the process includes depositing at least one alloying element onto one of the plurality of substrates to form a first coating composition carried by that substrate. The coating composition comprises alloying element(s), and the alloying element(s) can be selected from the group consisting of titanium, zirconium, vanadium, niobium, tantalum, chromium, molybdenum, tungsten, manganese, iron, cobalt, rhodium, nickel, copper, silver, zinc, aluminum, silicon, and a mixture thereof. In one preferable example, the alloying element(s) include(s) chromium. In another example, the combined substrate thickness and coating composition thickness are, preferably, substantially similar to the product specification thickness criterion. That is, the sum of the substrate thickness and coating composition thickness is within about 250 μm, 200 μm, 150 μm, 100 μm, or 50 μmm of the specification thickness criterion. In another example, depositing the alloying element(s) can include a deposition process selected from the group consisting of chemical vapor deposition, physical vapor deposition, thermalspray, electrochemical deposition, electroless deposition, and a mixture thereof.

The process further includes annealing the first coating composition and the coated substrate to form a first product that meets the first surface specification and the first core specification. In one example, annealing includes heating the first coating composition carried by that substrate to an annealing temperature for an annealing time which are sufficient to provide the first surface alloy composition and the first core composition. In one preferable example, the annealing provides a first surface alloy composition that is approximately equal to the first core composition. Finally, the compliance of the product produced by the process is then checked against the product specification.

The steel customization process can further include receiving a second product specification and producing a second product that meets that second specification by the above disclosed process. That is, the above process can further include converting a second product specification to a second surface specification that includes a second surface alloy composition and a second surface alloy thickness, and a second core specification that includes a second core composition and a second core thickness; depositing at least one alloying element onto a second of the plurality of substrates to form a second coating composition carried by that substrate; annealing the second coating composition and the second coated substrate to form a second product that meets the second surface specification and the second core specification; and then confirming that the second product meets the second product specification. While the second product can be the same as the first product (e.g., multiple runs of the same product for a single customer), the process, preferably, include producing a second product that is not the same as the first product. That is, the first product specification and the second product specification are not the same. Preferably, the difference between the first product specification and the second product specification is a difference in their compositions while the thicknesses can be the same.

In another embodiment, the steel manufacturing process can include receiving an order for a stainless steel product that includes performance, thickness, and composition criteria; then providing a carbon steel substrate; depositing at least one alloying element selected from nickel and chromium onto the carbon steel substrate, at a temperature below an annealing temperature, thereby forming a coating composition that is carried by the carbon steel substrate; then annealing the coating composition and the carbon steel substrate to form a stainless steel product; and then satisfying the order by providing the stainless steel product. In one example, the stainless steel product consists of a stainless steel layer carried by a core composition that is carbon steel. In another example, the stainless steel product has an approximately consistent composition throughout the stainless steel product. In still another example, the carbon steel substrate has a thickness less than about 2 mm; and wherein the stainless steel product thickness is less than about 2 mm.

In still another embodiment, the herein described late-stage customization of steels, alloys, or other metals employs steel as a starting substrate and is therefore a steel customization process. In a first example of this embodiment, the steel customization process can include receiving a product specification that can include performance or composition criteria; converting the product specification to a surface specification that can include a surface alloy composition and a surface alloy thickness, and a core specification that can include a core composition and a core thickness. The process can then include treating a substrate with a deposition composition (e.g., at a temperature below an annealing temperature) and thereby depositing at least one alloying element onto the substrate to form a coating composition carried by the substrate. Optionally, the process can include annealing the coating composition and the substrate to form a product that can include the surface specification and the core specification. Lastly, the process can include confirming that the product meets the product specification.

In another example, the steel customization process includes the production of multiple products (e.g., a first product and a second product) from, preferably, a single substrate stock. In this example, the steel customization process first includes the steel customization process described above. For example, the process can include receiving a first product specification; converting the first product specification to a first surface specification that includes a first surface alloy composition and a first surface alloy thickness, and a first core specification that includes a first core composition and a first core thickness; treating a first substrate with a first deposition composition thereby forming a first coating composition that is carried by the first substrate; then annealing the first coating composition and the first substrate to form a first product that includes the first surface specification and the first core specification; and confirming that the first product meets the first product specification. This example further includes receiving a second product specification that includes performance or composition criteria; converting the second product specification to a second surface specification that includes a second surface alloy composition and a second surface alloy thickness, and a second core specification that includes a second core composition and a second core thickness; treating a second substrate with a second deposition composition, at a temperature below an annealing temperature, thereby depositing at least one alloying element onto the substrate to form a second coating composition that is carried by the second substrate; annealing the second coating composition and the second substrate to form a second product that includes the second surface specification and the second core specification; and then confirming that the second product meets the second product specification. In this example, the first surface alloy composition and the second surface alloy composition are not the same; but the first core composition and second core composition are the same (that is, have they have the same composition). As a result, two products based on two product specifications, are produced from substrates that have the same composition. Preferably, where the substrates are parts cut from a single batch of substrate starting material (e.g., one batch of molten steel).

In further examples, a third product or a plurality of products can be produced using following the procedures outlined above. In some examples, the first and the third product can have the same or substantially the same product specification. In other examples, the product specifications, and thereby the resultant products, can have substantially different surface chemistries. Furthermore, the substrate can be cut form a single batch of substrate starting material or produced on a continuous line (e.g., via continuous casting).

In one particular example, the product specification (or specifications) is received from a purchaser (or purchasers). That is, instead of offering or in addition to offering, a standard catalogue of products, the product specification can be customized for each purchaser. As such, the purchaser can specify performance or composition criteria, thicknesses, and even the amount or volume of the product. Preferably, the product specification includes a thickness criterion (e.g., the thickness can be the distance from a first major surface to a parallel and opposing second major surface of the product, or the diameter of a wire). The process for receiving the product specification can be automated. For example, a purchaser interface can provide selection options that can be selected by the purchaser and that generate the product specification. Alternatively, the purchaser interface can provide standardized or prearranged selection options that can correspond to standard grades of commercial materials (e.g., 304SS, 314SS) in addition to selection options corresponding to size and shape criteria (e.g., thickness, volume, shape, length). The purchaser interface can be, for example, a website or other electronic order form.

The purchaser interface can be configured to communicate with a production controller. The production controller can include data on on-going and scheduled substrate production and substrate customization activities (e.g., processes), as well as, materials on hand, and material costs. Preferably, the production controller can provide estimates on, for example, the cost of a product meeting a purchaser-provided product specification, a time necessary to manufacture the product, and/or a delivery date based on a commitment to the purchase of the product. The production controller can further provide steel mill operation control, which for example can automate the production of the customized steel product.

The steel customization process can further include converting the product specification to a deposition specification. The deposition specification typically includes a substrate composition, a substrate thickness, and a coating composition thickness. Aspects of the deposition specification can be adapted or provided from results based on the deposition of volatile deposition agents onto substrates. Further aspects of the deposition specification can be determined directly from the product specification. The deposition specification preferably includes the substrate composition, substrate thickness, coating composition, coating composition thickness, and processing requirements (e.g., annealing temperatures and annealing times).

The product specifications for, for example, wire and coil typically include a thickness criterion (e.g., the wire gage or foil/coil thickness). Preferably, the combination of the substrate thickness and the coating composition thickness is substantially similar to the product specification's thickness criterion. In this example, the deposition specification included coating composition thickness can be determined from the substrate thickness and the product specification; that is, the product thickness is linearly/directly dependent on the combination of the substrate thickness and the coating composition thickness (e.g., the product thickness is the sum of the substrate thickness and the coating composition thickness).

In aspects of the process where the product thickness is not linearly dependent on the combination of the substrate thickness and the coating composition thickness, the sum of the substrate thickness and the coating composition thickness may be substantially greater than the product thickness (e.g., the coating composition and/or the substrate may have a density less than the density of the product). Further aspects of the process can include reforming the product after a coating composition is applied (e.g., hot/cold rolling the coated substrate and/or the product) and correspondingly the product thickness may be significantly different from the combination of the substrate thickness and the coating composition thickness.

Still further, the steel customization process can include selecting the deposition composition from a predetermined class of volatile deposition agents and, optionally, a carrier gas. Preferably, the volatile deposition agent is selected from the group consisting of a metal alkyl, a metal alkylamide, a metal amine, a metal cyclopentadienyl, a metal acetylacetonate, a metal carbonyl, a metal hydride, and a mixture thereof. More preferably, the volatile deposition agent is selected from the group consisting of a metal carbonyl, a metal hydride and a mixture thereof. Even more preferably, the volatile deposition agent is a metal carbonyl. Examples of volatile deposition agents can be found in the Handbook of Chemical Vapour Deposition (CVD), Principles, Technology, and Applications, 2^{nd} Edition, Hugh O. Pierson, 1999, Noyes Publications, incorporated herein by reference. Examples of metal carbonyls include, but are not limited to, Cr(CO)₆, Mn(CO)₆, Fe(CO)₅, Co₂(CO)₈, Ni(CO)₄, Mo(CO)₆, or mixtures thereof. The carrier gas can be selected from H₂, CO, CO₂, N₂, Ar, or mixtures thereof.

In one embodiment, the steel customization process includes casting molten steel to produce the substrate or substrates. The casting process, generally, includes heating iron to a temperature above its melting point, optionally to a temperature above a eutectic alloys melting point, when the metal being cast is a eutectic alloy. The casting process can include any casting method; preferably the casting or casting process is selected from the group consisting of curved casting, horizontal casting, and thin strip casting. Optionally, the casting can be thin strip casting; or the casting can be curved casting followed by hot rolling.

In an example where a plurality of steel substrates is manufactured and, optionally, a plurality of products are manufactured, the process can include the continuous casting of molten steel on one steel production line to form a plurality of steel substrates. These steel substrates, preferably, have substantially the same compositions and dimensions. For example, one steel production line can produce both the first substrate and the second substrate. That is, substrates cut from a continuous casting of molten steel should, and preferably do, have substantially the same composition independent of the time at which the substrates are cut from the casting. Thereby, a continuously casting, steel production line can produce a plurality of substrates with substantially the same composition and dimensions.

The substrate can have a substrate composition that includes iron. The substrate composition can be carbon steel, preferably, low carbon steel, and more preferably very low carbon steel. In one example, the product's core composition is essentially the same as the substrate composition. That is, the process described herein, preferably, can affect a surface of the substrate but does not change the composition of the material at a distance furthest from a surface (i.e., at the substrate's core). In some examples, the core composition can extend throughout the majority of the product, that is, the surface or surface composition extends a limited distance into the substrate, e.g., less than 1000 microns, 500 microns, 250 microns, 100 microns, 50 microns, 10 microns, 5 microns, 1 micron, or 0.5 microns.

The substrate can further be a spheroidite steel, coarse pearlite steel, annealed steel, normalized steel, martempered steel, tempered steel, or bainite steel. In one example, the substrate is an annealed carbon steel.

The shape of the substrate can vary dependent on the desired product. For example, the substrate can be a bar, tube, wire, plate, or coil. The substrate can alternatively be a finished metal object or have a finished shape, for example, a fastener, a casement (e.g., a cellphone or computer case), engine part (e.g., engine block, piston, valve, exhaust part), a wheel part, a bicycle frame, a gear wheel, or kitchen or eating utensil. In one preferred example, the substrate is a steel coil; more preferably, the substrate is an open steel coil.

The coating process, generally, includes depositing a material onto the surface of the substrate to form a coating composition. The coating composition can be a single layer of a pure element (e.g., nickel), can be a single layer of an alloy (e.g., nickel and chromium), or can be a plurality of layers (e.g., where each layer is the same element (i.e., multiple layers of, for example, nickel) or where layers include different elements or different compositions). In one preferable example, the coating composition includes a plurality of alloying element layers. Each alloying element layer, preferably, includes at least one alloying element selected from the group consisting of titanium, zirconium, vanadium, niobium, tantalum, chromium, molybdenum, tungsten, manganese, iron, cobalt, rhodium, nickel, copper, silver, zinc, aluminum, and silicon. More preferably, each alloying element layer is a layer of a single element (a pure alloying element) or an alloy of elements (a plurality of different alloying element in a single layer), where the alloying element is selected from the group consisting of titanium, zirconium, vanadium, niobium, tantalum, chromium, molybdenum, tungsten, manganese, iron, cobalt, rhodium, nickel, copper, silver, zinc, aluminum, and silicon. Even more preferably, the coating composition includes a plurality of layers where at least (1) one alloying element layer is a layer of iron, and/or (2) one alloying element layer is an alloy of iron and at least one alloying element selected from the group consisting of titanium, zirconium, vanadium, niobium, tantalum, chromium, molybdenum, tungsten, manganese, cobalt, rhodium, nickel, copper, silver, zinc, aluminum, and silicon.

In these examples, the coating composition can be iron and at least one alloying element; where the alloying element is selected from the group consisting of titanium, zirconium, vanadium, niobium, tantalum, chromium, molybdenum, tungsten, manganese, cobalt, rhodium, nickel, copper, silver, zinc, aluminum, and silicon. More preferably, the coating compositions described above include an alloying element selected from titanium, molybdenum, chromium, nickel, aluminum, and silicon; even more preferably the coating compositions include an alloying element selected from molybdenum, chromium and nickel; and still more preferably an alloying element selected from chromium and nickel.

The coating composition can be formed by treating the substrate with the deposition composition (e.g., at a temperature below an annealing temperature) and thereby depositing an alloying element or alloying element layer onto the substrate. The treatment of the substrate with the deposition composition, preferably, includes the chemical vapor deposition of at least one of the alloying element from a volatile deposition agent.

The herein described process can, optionally, include annealing the coating composition and the substrate to form a product that can include the surface specification and the core specification. In one example, the annealing process can include enclosing the substrate in a deposition chamber; annealing the coating composition and the substrate within the deposition chamber; and then removing the product from the deposition chamber. This example can further include coating the substrate with the coating composition within the deposition chamber, that is, the coating and annealing are completed in a single deposition chamber (e.g., a deposition-annealing furnace). In another example, the coating and annealing process can include enclosing the substrate in a deposition chamber; coating the substrate with the coating composition; moving the substrate carrying the coating composition to an annealing furnace; annealing the coating composition and the substrate in the annealing furnace; and then removing the product from the annealing furnace. In an example where a plurality of products are being formed, the steel customization process can include removing the first steel product from the deposition chamber after treating the first substrate with the first deposition composition; positioning the second steel substrate in the deposition chamber; then treating the second steel substrate with the second deposition agent; and then removing the second product from the deposition chamber. In yet another example where a plurality of products are being formed, the steel customization process can include moving a first coated composition for the deposition chamber to the annealing furnace and positioning the second substrate in the deposition chamber, then annealing the first coated composition while coating the second substrate; and then moving the second substrate to the same or a different annealing furnace. Notably, when the time required for deposition (e.g., a deposition time) is comparable (e.g., the difference is less than 24 hours) to the annealing time, a single deposition chamber and single annealing furnace can be operated in tandem. Alternatively, when the deposition time is short and the annealing time is long (e.g., when the annealing time is multiples of the deposition time, for example twice as long), a single deposition chamber be operated with a plurality of annealing furnaces operated in parallel.

In one preferable example, the steel customization process includes the casting of the substrate and before the substrate cools the coating of the substrate. For example, the process can be substantially free of cooling the substrate to a temperature of less than 50° C., 100° C., 150° C., 200° C., 250° C., 300° C., 350° C., 400° C., 450° C., 500° C., 550° C., 600° C., 650° C., or 700° C. until after annealing. Preferably, the substrate is manufactured (e.g., cast and shaped) and then treated with the deposition agent without cooling to a temperature of less than 200° C., less than 300° C., less than 400° C., or less than 500° C. until after annealing. Even more preferably, the substrate is treated with the deposition agent at a temperature of less than about 500° C., 400° C., or 300° C.

In one particularly preferable example, the steel manufacturing process includes receiving an order for a stainless steel product that includes performance or composition criteria; then providing a carbon steel substrate that is sufficient to carry a stainless steel layer; depositing at least one alloying element selected from nickel and chromium, optionally including iron, onto the carbon steel substrate, at a temperature below an annealing temperature, thereby forming a coating composition that is carried by the carbon steel substrate; then annealing the coating composition and the carbon steel substrate to form a stainless steel product that carries the stainless steel layer and includes a core composition that is carbon steel; and then satisfying the order by providing the stainless steel product that carries the stainless steel layer and that includes the core composition that is carbon steel.

In another example, the steel manufacturing process can further include providing a deposition layer carried by the product. That is, the process can include treating the substrate with a deposition composition to form the coating composition carried by the substrate, annealing the coating composition and the substrate, and then depositing another coating composition upon the annealed product.

In still another example, the steel manufacturing process can further include providing an overcoating to the (annealed) product. The overcoating can be, for example, a layer of an alloying element (e.g., the same alloying element that is impregnating the sponge-iron layer, or a different alloying element), a plurality of alloying elements (e.g., as an alloy layer or as distinct/individual layers), an oxide (e.g., a silicon oxide, an aluminum oxide, or a transition metal oxide), or a nitride (e.g., a silicon nitride, or a transition metal nitride).

1-11. (canceled)

12. A steel manufacturing process comprising:
receiving an order that includes performance, thickness, and composition criteria; then
providing a first carbon steel substrate;
depositing at least one alloying element selected from nickel and chromium onto the first carbon steel substrate, at a temperature below an annealing temperature, thereby forming a coating composition that is carried by the first carbon steel substrate; then
annealing the coating composition and the first carbon steel substrate to form the a first stainless steel product, wherein the first stainless steel product has a stainless steel layer metallurgically bonded to a core composition that is carbon steel, the stainless steel layer meeting the performance and composition criteria, and the stainless steel layer having a concentration of the deposited alloying element that varies by less than 5 wt. %; and then
satisfying the order by providing the first stainless steel product.

13. The steel manufacturing process of claim 12, wherein the first stainless steel product consists of a stainless steel layer carried by a core composition that is carbon steel.

14. (canceled)

15. The steel manufacturing process of claim 12, wherein the first carbon steel substrate has a thickness less than about 2 mm; and wherein the first stainless steel product thickness is less than about 2 mm.

16. The steel manufacturing process of claim 12 further comprising:
receiving an order for a second stainless steel product that includes performance, thickness, and composition criteria, where the first stainless steel product composition and the second stainless steel product composition are not the same; then
providing a second carbon steel substrate;
depositing at least one alloying element selected from nickel and chromium onto the second carbon steel substrate, at a temperature below an annealing temperature, thereby forming a coating composition that is carried by the second carbon steel substrate; then
annealing the coating composition and the carbon steel substrate to form the second stainless steel product; and then
satisfying the order by providing the second stainless steel product.

17. The steel manufacturing process of claim 16, wherein the first carbon steel substrate and the second carbon steel substrate have substantially the same compositions and dimensions.

18. The steel manufacturing process of claim 17, wherein the first carbon steel substrate and the second carbon steel substrate are steel coil.

19. The steel manufacturing process of claim 12 further comprising depositing nickel and chromium onto the first carbon steel substrate.

20. The steel manufacturing process of claim 16 further comprising depositing nickel and chromium onto the second carbon steel substrate.

21. The steel manufacturing process of claim 12, wherein the stainless steel layer has a thickness of about 5 μm to about 250 μm.

22. A steel manufacturing process comprising:
receiving an order that includes performance, thickness, and composition criteria; then
providing a first carbon steel substrate;
depositing chromium onto the first carbon steel substrate, at a temperature below an annealing temperature, thereby forming a coating composition that is carried by the first carbon steel substrate; then
annealing the coating composition and the first carbon steel substrate to form a first stainless steel product, wherein the first stainless steel product has a stainless steel layer metallurgically bonded to a core composition that is carbon steel, the stainless steel layer meeting the performance and composition criteria, and the stainless steel layer having a chromium concentration that varies by less than 5 wt. %; and then
satisfying the order by providing the first stainless steel product.
